(19) United States
(12) Patent Application Publication
(10) Pub. No.: US 2024/0317477 A1
(43) Pub. Date: Sep. 26, 2024

(54) COMPOSTABLE CONTAINER

(71) Applicant: Northwest IP Holdings, LLC, Clackamas, OR (US)

(72) Inventor: Adam Gysin, Clackamas, OR (US)

(73) Assignee: Northwest IP Holdings, LLC, Clackamas, OR (US)

(21) Appl. No.: 18/188,141

(22) Filed: Mar. 22, 2023

(51) Int. Cl. B65D 65/46; B65D 43/16; C08K 3/22; C08L 67/04

(52) U.S. Cl. CPC B65D 65/466; B65D 43/169; C08K 3/22; C08L 67/04; C08K 2003/2241; C08L 2201/06

(57) ABSTRACT

A biodegradable and compostable material formed into a closable container, which is biodegradable in a home composting environment. The material is preferentially free from ingredients which are more burdensome to the environment to manufacture.

### CROSS REFERENCE TO RELATED APPLICATIONS

Not applicable.

### BACKGROUND OF THE INVENTION

None.

### SUMMARY OF THE INVENTION

The present disclosure is directed to a biodegradable and compostable material formed into containers, which may be compostable in a home environment.

Biodegradable packaging is an alternative to plastic that helps alleviate the long term issues presented by excessive plastic usage. Biodegradable packaging is made of renewable materials, whereas plastics are made of oil. Biodegradable packaging is presented as non-toxic to natural environments or humans.

Consumers often falsely assume that all such biodegradable packaging which is placed in a recycling bin is recycled. This is far from the truth, as over 90 percent of recycled packaging ends up in landfills. It is difficult to assess the success rate of industrial composing facilities that accept a variety of biopolymers. Industrial composting facilities boast special equipment for mechanically breaking down packaging into smaller sized material. They may be mixed with other animal products.

There is a need for packaging which is compostable in a home compositing environment and is also suitable for use as containers, bags, and films.

### BRIEF DESCRIPTION OF THE DRAWINGS

For a better understanding of the disclosure, and to show how the same may be carried into effect, reference will now be made, by way of example to the accompanying drawings, which:

FIG. 1 shows an open perspective view of an embodiment of the present disclosure;

FIG. 2 shows a closed perspective view of the embodiment of the present disclosure.

FIG. 3 shows an open side view of the embodiment of the present disclosure.

FIG. 4 shows a closed side view of the embodiment of the present disclosure.

FIG. 5 shows a closed cross section view of the embodiment of the present disclosure.

FIG. 6 shows an enlarged detailed view of a latch portion of the embodiment of the present disclosure.

### DETAILED DESCRIPTION

The present disclosure is directed to a biodegradable and compostable material formed into containers, which may be compostable in a home environment. Such compostable packaging could be used to store consumables and cosmetics, sometimes within other containers. Such compostable bags are preferably strong, flexible, and resistant to temperature or moisture change, making them excellent for long term storage or for products that are shipped extended distances.

“Biodegradables”, according to the American Society for Testing and Materials (ASTM), are anything that undergoes degradation resulting from the action of naturally occurring microorganisms such as bacteria, fungi, and algae. “Compostables”, according to the ASTM, are products capable of breaking down into natural elements in a compost environment. The ASTM defines compostables as anything that undergoes degradation by biological processes during composting to yield CO2, water, inorganic compounds and biomass at a rate consistent with other compostable materials and leaves no visible, distinguishable or toxic residue.

European Standard EN 13432 sets criteria for what can or cannot be described as compostable and what can be called biodegradable. The US Standard ASTM D6400-99 also sets out similar standards.

Biodegradable packaging is produced using biopolymers, which are molecules often found in living organisms, like cellulose and proteins. This frequently means they can be safely consumed, degrade quickly, and can even be created from waste plant products.

The biopolymers used in biodegradable packaging are produced in a few different ways, but usually in a process which requires much less energy than the production of plastic polymers. One of the most common production methods is extracting them directly from plant matter. Starch based packaging is arguably the most common type of biopolymer produced from green plants, like potatoes, corn, rice, etc., which are heated and starch molecules directly extracted from them. The starch biopolymers are then processed, heated, and turned into a final package shape. Starch is a very accessible and low cost biopolymer. Starch based polymers have been proven to successfully replace polystyrene and polyethylene plastics.

Another common biopolymer often used in conjunction with starch is chitin. Chitin is commonly found in the skin of insects, cell walls of fungi, and shells of shellfish. Biodegradable films are commonly made with a mix of starch and chitin as they have been shown to have good antimicrobial properties. These films are used in food packaging and as an edible coating for fruits and vegetables. The starch-chitin based coatings work well in conjunction with metal packaging, as they coat perishables and prevent them from coming into contact with air.

Not all biopolymers can be composted at home and require special composting facilities to be effectively composted.

Presented herein is a novel composition to be used in manufacture of a storage container which can be opened and closed. The composition is comprises essentially of 90-98% polyhydroxyalkanoate (PHA) and 1-10% titanium dioxide. The PHA preferably used is Danimer 3359, but those skilled in the art will appreciate that similar PHAs could be employed. The titanium dioxide is used for obtaining white pigmentation but other colors may be preferred and compostable pigments used to obtain those.

The composition is essentially free of polylactic acid (PLA), which is known to require a high volume of water to manufacture.

In one preferred composition, composition A is 98% PHA, and 2% titanium dioxide. In another preferred composition, composition B is 90-94% PHA, 3 and 6-10% titanium dioxide.

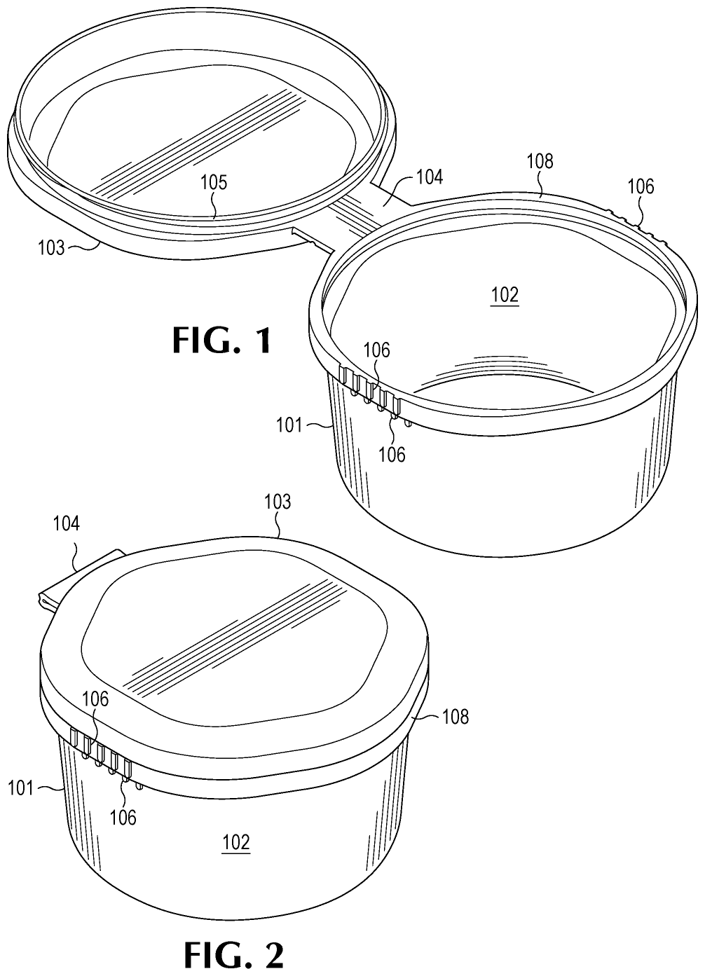

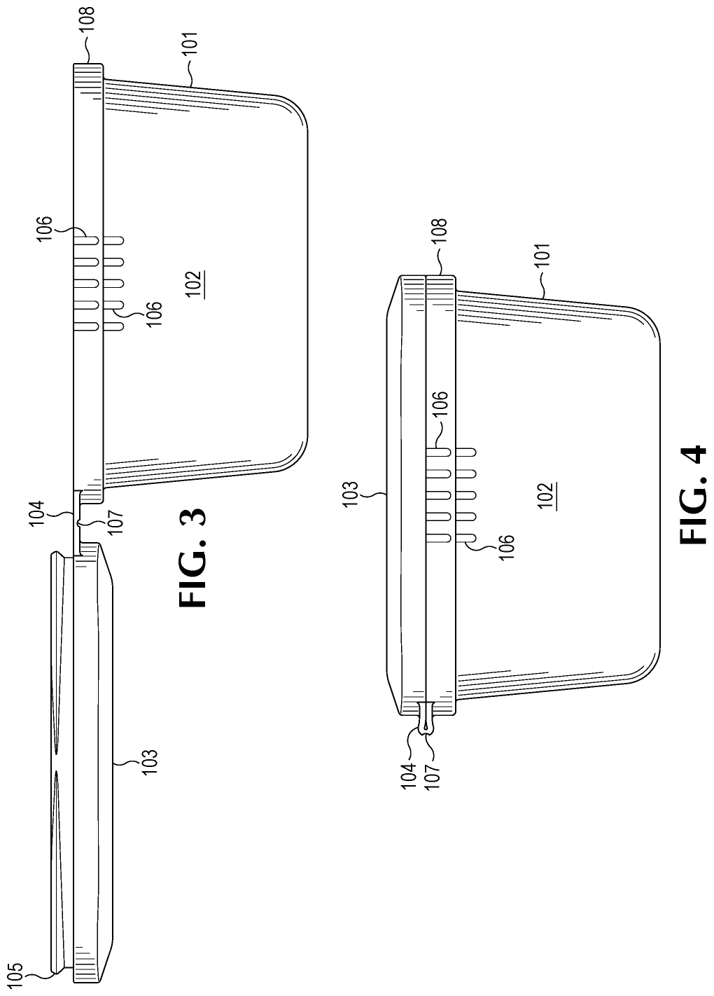

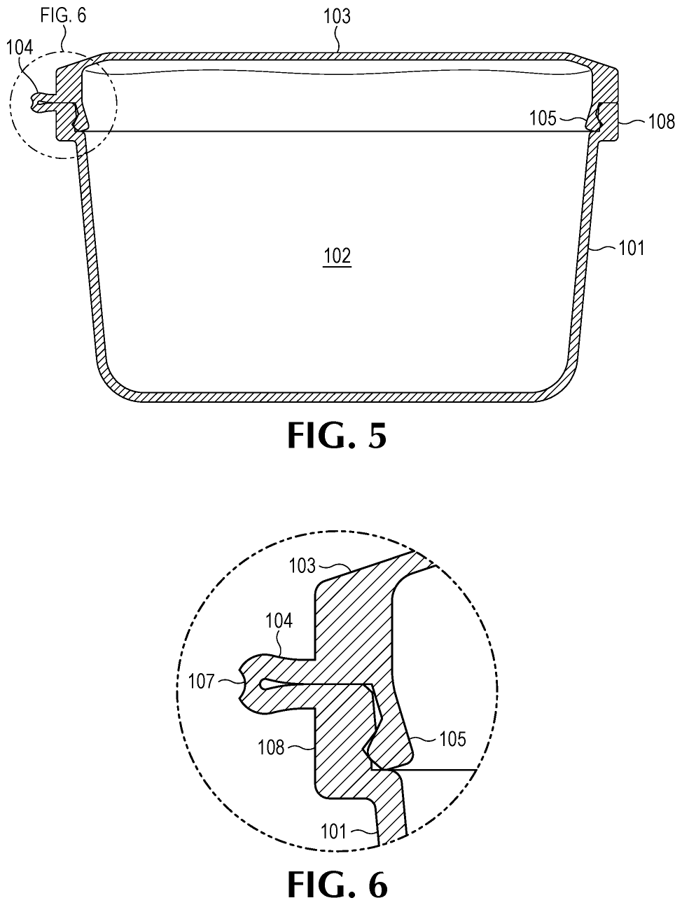

Composition A is resiliently deformable, making it well suited for a hinged dram 101 of FIG. 1, which includes a hinged lid 103, and is child resistant. Squeezing sidewall 102 facilitates the hinged lid 103 to open. Sidewall 102 may have plurality of traction elements 106 which facility gripping the dram 101.

Sidewall 102 has sidewall ridges 108 which encircle most the of edge of the sidewall. Sidewall ridges 108 are shaped to matingly engage with lid ridges 105 which encircle most an edge of the lid 103. The sidewall ridges and lid ridges engage with each other being pressed with sufficient force to urge them past each ridge crest until the lid ridges lie interior of the sidewall ridges. Compositions described herein have sufficient resilience to allow the ridges to deform during pressing and resile such that the crests sit within respective valleys.

Hinge 104 is joins lid 103 to the dram 101, so all components may be integrated and formed of the compositions described herein.

Hinge 104 has an axis 107 allow hinge 104 to flexibly move from a closed position to an open position. As shown, axis 107 is a shallow channel on at least the outer side of hinge 104.

Those skilled in the art will appreciate that dram 101 may be sized and shaped to accommodate the intended product.

It will be appreciated that the disclosure is not restricted to the particular embodiment that has been described, and that variations may be made therein without departing from the scope of the disclosure as defined in the appending claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. A compostable container substantially free of virgin petroleum-based compounds, the container comprising a body and a lid,
(a) the container comprising:
(i) 90-94% PHA which is not PLA; and
(ii) 6-10% titanium dioxide; and
(b) the lid integrally mated to the body at a flexible hinge;
the body and the lid comprising more than 90% polymer biodegradable within 6 months;
where a hinge located between the lid and the body reversibly folds along an axis to bring body sidewall ridges into mating engagement with lid ridges.

2. The compostable container of claim 1 where the PHA is 90% and the titanium dioxide is 10%.

3. The container of claim 1, where the axis is a channel.

4. A method of providing a container which is fully compostable within 6 month, the method comprising the steps of:
(a) selecting a PHA which is not PLA;
(b) forming a container having a flexible hinge with an integral lid, where the lid and a body of the container are capable of reversibly mating by engagement of integral lid ridges and sidewall ridges.
